(19) United States
(12) Patent Application Publication
(10) Pub. No.: US 2012/0114083 A1
(43) Pub. Date: May 10, 2012

(54) METHOD FOR GENERATING MODULATED RADIO-FREQUENCY SIGNAL WITH HIGH DYNAMIC RANGE

(75) Inventors: Jau-Horng Chen, Taipei (TW); Yi-Jan Emery Chen, Taipei (TW)

(73) Assignee: NATIONAL TAIWAN UNIVERSITY, Taipei (TW)

(21) Appl. No.: 13/100,535

(22) Filed: May 4, 2011

(30) Foreign Application Priority Data
Nov. 10, 2010 (TW) 99138621

(51) Int. Cl. H04L 27/08

(52) U.S. Cl. 375/345

(57) ABSTRACT

A method for generating a modulated RF signal with high dynamic range is disclosed, which electrically combines average output power adjustment and instantaneous output power adjustment to improve the dynamic range of output power of an RF signal. Compared to the single control mechanism in the traditional method for generating a modulated RF signal, the method for generating a modulated RF signal proposed by the present invention can be applied to produce a variety of highly efficient RF transmitters with high dynamic range.

### FIELD OF THE INVENTION

The present invention relates to methods for generating a radio-frequency (RF) signal, and, more particularly, to a method for generating a modulated RF signal with high dynamic range.

### BACKGROUND OF THE INVENTION

Advanced cellular mobile communication standards, such as CDMA2000, WCDMA and the like, use dynamic power control to improve spectral efficiency. Through dynamic power control, when a cellular phone is close to a base station, the output power of the radio-frequency (RF) transmitter of the cellular phone is reduced, whereas when the cellular phone is far from the base station, the output power of its RF transmitter is increased. In communication standards, such as CDMA2000 and WCDMA, the dynamic range of the output power is approximately 80 dB in an attempt to reduce interference between users and prolong the time in which the phone is operable.

Traditionally, an RF transmitter is implemented with a linear power amplifier. By adjusting the input power of this power amplifier, the RF transmitter can obtain a power output with a dynamic range of 80 dB. However, this linear power amplifier is not efficient such that the efficiency will drop rapidly when backed off from the maximum output power level and severely reduce the operational time of the phone.

Prior art has disclosed a power-level tracking technique, which essentially adds a DC-DC converter between the power supply of the RF transmitter and the linear power amplifier, so that the power supply voltage of the linear power amplifier can be adjusted by the DC-DC converter. By dynamically adjusting the power supply voltage, the efficiency of the linear power amplifier can be improved significantly, when compared to a conventional RF transmitter. However, since a linear power amplifier is employed, its efficiency is still relatively low.

The envelope elimination and restoration (EER) transmission technique described in “L-band transmitter using Kahn EER technique” (IEEE Trans. Microwave Theory Tech., vol. 46, no. 12, pp. 2220-2225, December 1998, E H. Raab, B. E. Sigmon, R. G. Myers, and R. M. Jackson) can significantly increase the efficiency of the RF transmitter when operated close to the maximum power level. However, a transmitter adopting the EER technique only has a single control mechanism, wherein both the fast-varying instantaneous output power level and the slow-varying average output power level are controlled concurrently by the information detected by the envelope detector. The single control mechanism is limited by the difference of the maximum and the minimum power supply voltages, which limits the dynamic range of the transmitted RF signals to less than 20 dB. As a result, the dynamic range does not comply with the regulations on the dynamic range of output power specified in the aforementioned communication standards.

In summary, a dynamic range of 80 dB for the power output can be obtained with the use of a linear power amplifier, but efficiency of the power output is poor; and, although said EER method mitigates poor efficiency, the dynamic range of the power output is inevitably reduced to below 20 dB.

Thus, there is a need for a method for generating a modulated RF signal that solves the prior art shortcomings, specifically, by not compromising either the average output efficiency or the dynamic range of output power.

### SUMMARY OF THE INVENTION

In the light of forgoing drawbacks, an objective of the present invention is to provide a method for generating a modulated RF signal with high dynamic range and to provide high average output efficiency while maintaining the output power in a range that complies with that specified by current communication standards such as CDMA2000, WCDMA and the like.

In accordance with the above and other objectives, the present invention provides a method for generating a modulated radio-frequency (RF) signal, comprising the steps of: generating a pulse modulation control signal, a gain control signal, and an average power control signal; receiving a constant-envelope modulated RF signal and the gain control signal by a variable gain module, and the variable gain module adjusting an amplifying gain of the constant-envelope modulated RF signal according to the gain control signal that sets the amplitude of the constant-envelope modulated RF signal to generate an constant-envelope modulated RF signal with an adjusted amplitude, and adjusting the DC supply voltage of a DC power supply to be output to a power amplification module according to the average power control signal to generate a power amplifier with adjusted average power, and receiving and modulating the constant-envelope modulated RF signal with an adjusted amplitude by an instantaneous power adjusting module according to the pulse modulation control signal to generate a pulse modulated RF signal carrying phase information; and receiving the pulse modulated RF signal carrying phase information and the power amplifier with adjusted average power by the power amplification module, and adjusting the output power of the received pulse modulated RF signal carrying phase information in its envelope by the power amplification module according to the power amplifier with adjusted average power, so as to output/generate a pulse modulated RF signal with adjusted power and carrying phase information.

In another implementation aspect of the method for generating an RF signal with high dynamic range of the present invention, the method includes: generating an instantaneous power control signal, a gain control signal, and an average power control signal; receiving an constant-envelope modulated RF signal and the gain control signal by a variable gain module, having the variable gain module adjust the amplifying gain of the constant-envelope modulated RF signal according to the gain control signal to adjust the amplitude of the constant-envelope modulated RF signal to generate an constant-envelope modulated RF signal with an adjusted amplitude, and then adjust the average power the DC supply voltage of a DC power supply to be output to a plurality of power amplification modules according to the average power control signal to generate a power amplifier with adjusted average power, and receiving and modulating the constant-envelope modulated RF signal with adjusted amplitude by each of a plurality of instantaneous power adjusting modules according to the instantaneous power control signal to simultaneously generate a plurality of modulated RF signals carrying phase information; receiving the plurality of modulated RF signals carrying phase information and the power amplifier with adjusted average power by the plurality of power amplification modules, and then simultaneously adjusting the output powers of the received modulated RF signals carrying phase information by the power amplification modules according to the power amplifier with adjusted average power, so as to output/generate a plurality of modulated RF signals with adjusted power and carrying phase information; and combining the plurality of modulated RF signals with adjusted power and carrying phase information in their envelopes to output/generate an RF signal with high dynamic range.

Compared to the prior art, the method for generating an RF signal with high dynamic range of the present invention adopts two power adjustment mechanisms to increase the dynamic range of output power. That is, on the one hand, adjustment of average output power can be achieved through the controlling of the DC power supply input of the RF amplifying module; on the other hand, fast adjustment of average output power can also be achieved through the adjustment of the amplitude of the constant-envelope modulated RF signal and pulse modulation (pulse width or duty cycle) of the constant-envelope modulated RF signal. Compared to the single control mechanism of the prior art, the method for generating an RF signal with high dynamic range of the present invention achieves a higher average power output efficiency while allowing the dynamic range of output power to comply with those required by current communication standards such as CDMA2000 and WCDMA.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram depicting a circuit for carrying out a method for generating a modulated RF signal with high dynamic range of the present invention;

FIG. 2 is a schematic diagram depicting another circuit for carrying out the method for generating a modulated RF signal with high dynamic range of the present invention;

FIGS. 3A and 3B are diagrams depicting signal waveforms of an input constant-envelope modulated RF signal and an output pulse modulated RF signal with adjusted power and carrying phase information using the circuitry shown in FIG. 1;

FIGS. 4A and 4B are diagrams depicting signal waveforms of an input constant-envelope modulated RF signal and an output RF signal with high dynamic range using the circuitry shown in FIG. 2;

FIG. 5 is a chart depicting a curve of power added efficiency obtained with an RF transmitter using the method for generating a modulated RF signal with high dynamic range of the present invention;

FIG. 6 is a chart depicting relationships between input and output powers obtained with an RF transmitter using the method for generating a modulated RF signal with high dynamic range of the present invention;

FIG. 7 is a chart depicting ACPR1 and ACPR2 (Adjacent Channel Power Ratio) curves obtained with an RF transmitter using the method for generating a modulated RF signal with high dynamic range of the present invention;

FIG. 8 is a chart illustrating a comparison between the efficiencies of a polar coordinated transmitter using the method for generating a modulated RF signal with high dynamic range of the present invention and a commercial linear power amplifier within 40 dB dynamic range;

FIG. 9 is a flowchart illustrating a method for generating a modulated RF signal with high dynamic range according to an embodiment of the present invention; and

FIG. 10 is a flowchart illustrating a method for generating a modulated RF signal with high dynamic range according to another embodiment of the present invention.

### DETAILED DESCRIPTION OF THE EMBODIMENTS

The present invention is described by the following specific embodiments. Those with ordinary skills in the art can readily understand other advantages and functions of the present invention after reading the disclosure of this specification. The present invention can also be implemented with different embodiments. Various details described in this specification can be modified based on different viewpoints and applications without departing from the scope of the present invention.

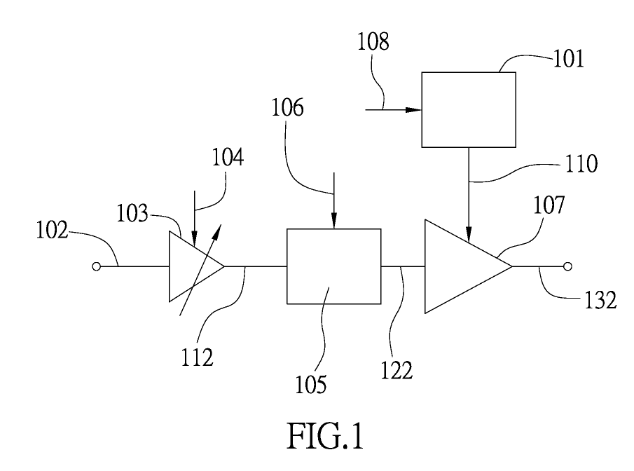

Referring to FIG. 1, a schematic diagram depicting a circuit for carrying out a method for generating a modulated RF signal with high dynamic range of the present invention is shown. The present invention is capable of producing higher dynamic range for the transmitted power of RF signals. This dynamic range complies with the 80 dB requirement specified by current communication standards (e.g. CDMA2000 and WCDMA).

As shown in FIG. 1, a variable gain module 103 receives a constant-envelope modulated RF signal 102 and a gain control signal 104. The variable gain module 103 adjusts the amplifying gain of the constant-envelope modulated RF signal 102 according to the gain control signal 104. Specifically, the variable gain module 103 adjusts the amplitude of the constant-envelope modulated RF signal 102 to generate a constant-envelope modulated RF signal with an adjusted amplitude 112.

Then, an average power adjusting circuit 101 adjusts the average power of the supply voltage of a DC power supply to be output to a power amplification module 107 according to an average power control signal 108 to generate a DC supply voltage with the adjusted average power 110. Thereafter, an instantaneous power adjusting module 105 receives the constant-envelope modulated RF signal with the adjusted amplitude 112, and modulates the constant-envelope modulated RF signal with the adjusted amplitude 112 according to a pulse modulation control signal 106 to generate a pulse modulated RF signal carrying phase information 122.

After the pulse modulated RF signal carrying phase information 122 is generated, the power amplification module 107 may receive the pulse modulated RF signal carrying phase information 122 and the DC supply voltage with the adjusted average power 110, and then the power amplification module 107 may adjust the power of the received pulse modulated RF signal carrying phase information 122 correspondingly according to the DC supply voltage with the adjusted average power 110, so as to output/generate a pulse modulated RF signal with the adjusted power and carrying phase information 132.

It should be noted here that the frequency (or duty cycle) of the constant-envelope modulated RF signal with the adjusted amplitude 112 may be modulated by the instantaneous power adjusting module 105.

Moreover, in another aspect of the present invention, the power amplification module 107 is an RF power amplifier.

Further, in another aspect of the present invention, the variable gain module 103 is a variable gain amplifier.

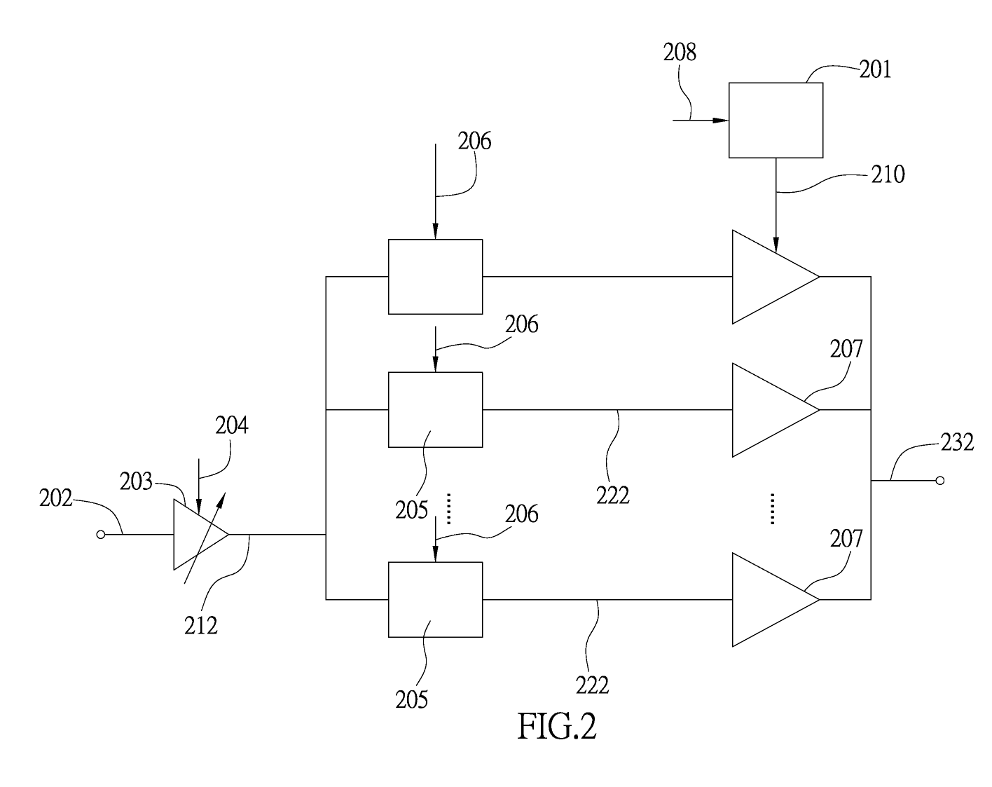

Referring to FIG. 2, a diagram depicting another circuit for carrying out the method for generating a modulated RF signal with high dynamic range of the present invention is shown. As shown in FIG. 2, a variable gain module 203 receives a constant-envelope modulated RF signal 202 and a gain control signal 204. The variable gain module 203 adjusts the amplifying gain of the constant-envelope modulated RF signal 202 according to the gain control signal 204. Specifically, the variable gain module 203 adjusts the amplitude of the constant-envelope modulated RF signal 202 to generate a constant-envelope modulated RF signal with adjusted amplitude 212.

Then, an average power adjusting circuit 201 adjusts the average power of the DC supply voltage of a DC power supply to be output to a plurality of power amplification modules 207 according to an average power control signal 208 to generate a DC supply voltage with the adjusted average power 210.

Thereafter, each of a plurality of instantaneous power adjusting modules 205 receive an constant-envelope modulated RF signal with the adjusted amplitude 212, and modulates the constant-envelope modulated RF signal with the adjusted amplitude 212 according to an instantaneous power control signal 206 to simultaneously generate a plurality of modulated RF signals carrying phase information 222. In other words, the instantaneous power adjusting modules 205 achieve adjustment of the instantaneous power by controlling the frequency or duty cycle of the signals.

After the plurality of modulated RF signals carrying phase information 222 are generated, the plurality of power amplification modules 207 may each receive a corresponding modulated RF signal carrying phase information 222 and the DC supply voltage with the adjusted average power 210, and then the plurality of power amplification modules 207 may simultaneously adjust the power of each received modulated RF signal carrying phase information 222 according to the DC supply voltage with the adjusted average power 210, so as to output/generate a plurality of modulated RF signals with adjusted power and carrying phase information.

Finally, the plurality of modulated RF signals with the adjusted power and carrying phase information can be combined to output/generate an RF signal with high dynamic range 232.

It should be noted that the functions of the instantaneous power adjusting modules 205 and the power amplification modules 207 can be realized by a power digital-to-analog converter (DAC).

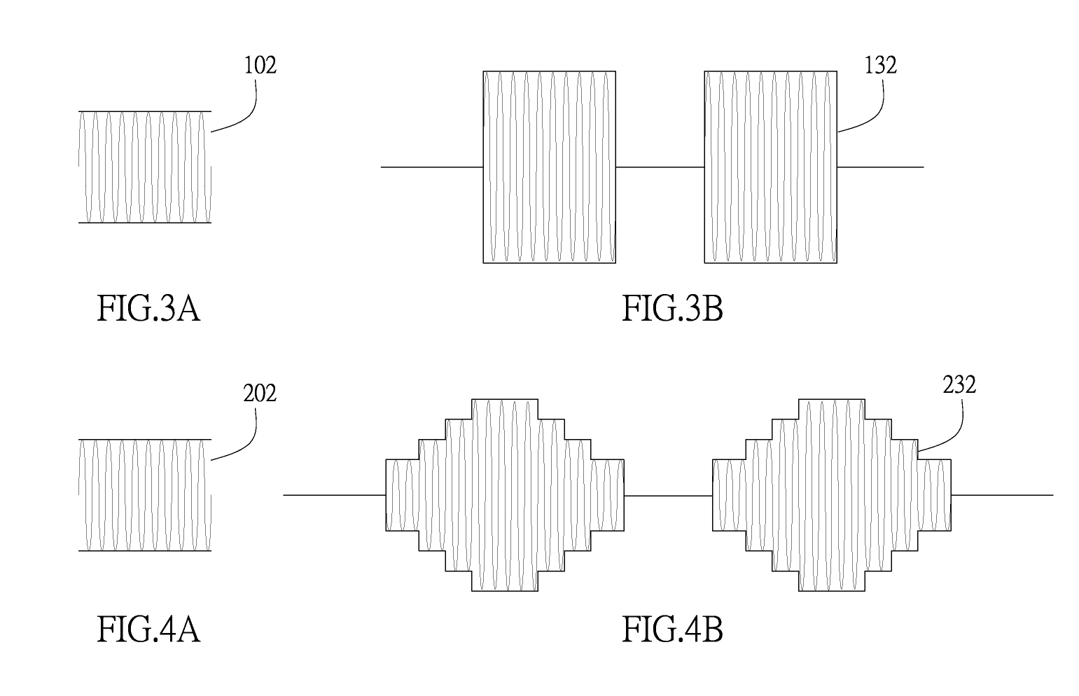

As shown in FIGS. 3A and 3B, diagrams depicting signal waveforms of a received input signal (e.g. constant-envelope modulated RF signal 102) and an output RF signal (e.g. pulse modulated RF signal with adjusted power and carrying phase information 132) are provided in conjunction with the circuitry shown in FIG. 1, wherein the waveforms depict an exemplary input signal 102 and output RF signal 132, respectively.

In addition, as shown in FIGS. 4A and 4B, diagrams depicting signal waveforms of the received input signal (e.g. constant-envelope modulated RF signal 202) and an output RF signal (e.g. an RF signal with high dynamic range 232) are provided in conjunction with the circuitry shown in FIG. 2, wherein the waveforms depict an exemplary input signal 202 and output RF signal 232, respectively.

Compared to the single control mechanism of the EER method in the prior art, the present invention adopts two power adjustment mechanisms to increase the dynamic range of the output power. On the one hand, slow adjustment of the average power in the millisecond timeframe can be achieved, while, on the other hand, fast adjustment of the average power in the microsecond timeframe can also be achieved, allowing the dynamic range of output power to comply with those required by current communication standards, such as CDMA2000 and WCDMA.

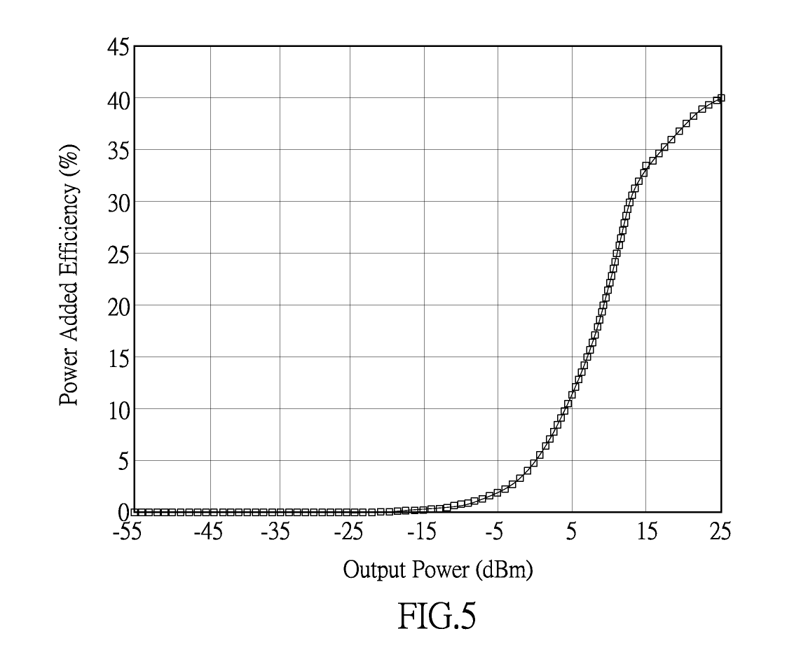

When the method for generating a modulated RF signal with high dynamic range of the present invention is applied to a polar coordinated transmitter, the output power efficiency of the polar coordinated transmitter is increased while exhibiting high dynamic range. In order to more clearly understand this, please refer to FIG. 5, which is a plot depicting a curve of power added efficiency.

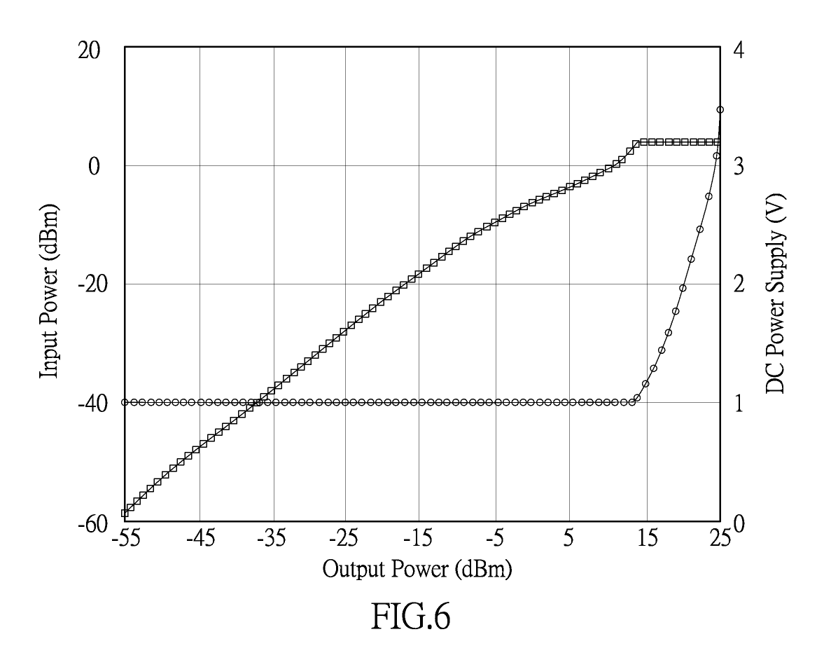

Moreover, as shown in FIG. 6, by using the method for generating a modulated RF signal with high dynamic range of the present invention, the dynamic range of the output power can be further improved to meet the 80 dB requirement specified by the current communication standards.

In addition, it is known from the CDMA2000 communication standard that the Adjacent Channel Power Ratio (ACPR1) should be lower than −42 dBc under a measuring bandwidth of 30 KHz or that the power should be lower than −54 dBm under a measuring bandwidth of 1.23 MHz, and that the Alternate Channel Power Ratio (ACPR2) should be lower than −54 dBc under a measuring bandwidth of 30 KHz or the power should be lower than −54 dBm under a measuring bandwidth of 1.23 MHz.

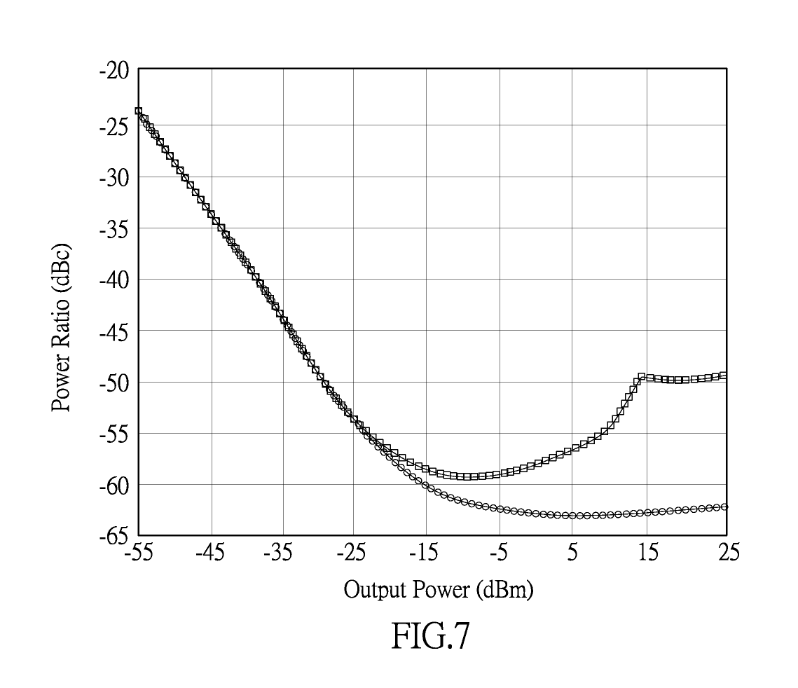

FIG. 7 is a plot depicting the RF output signal obtained using the method for generating a modulated RF signal with high dynamic range of the present invention by a spectrum analyzer. It can be seen from FIG. 7, when the output power varies within the 80 dB dynamic range, the ACPR1 and the ACPR2 both comply with the CDMA2000 communication standard. In FIG. 7, the curve consisting of small squares indicates the performance of ACPR1, and the curve consisting of small circles indicates the performance of ACPR2.

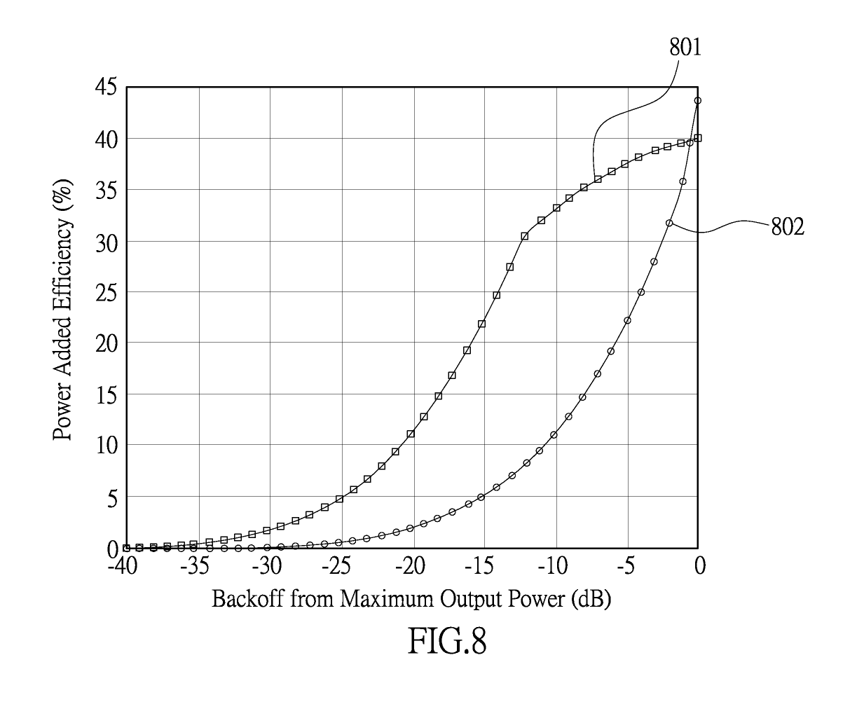

Referring now to FIG. 8, a comparison between the efficiencies of a polar coordinated transmitter using the method for generating a modulated RF signal with high dynamic range of the present invention and a commercial linear power amplifier within a 40 dB dynamic range is shown. As can be seen in FIG. 8, compared to curve 802 (using the commercial linear power amplifier), curve 801, which indicates the efficiency of the polar coordinated transmitter using the method for generating a modulated RF signal with high dynamic range of the present invention, has an improved power output efficiency when the output power is close to the maximum output power.

It can be seen from above FIGS. 3 to 6 that the method for generating a modulated RF signal with high dynamic range of the present invention provides an RF signal with high efficiency and high dynamic range (80 dB) for output power through two simultaneous power adjusting mechanisms, namely, pulse width/amplitude modulation and dynamic voltage regulation of the drain of the power amplifier.

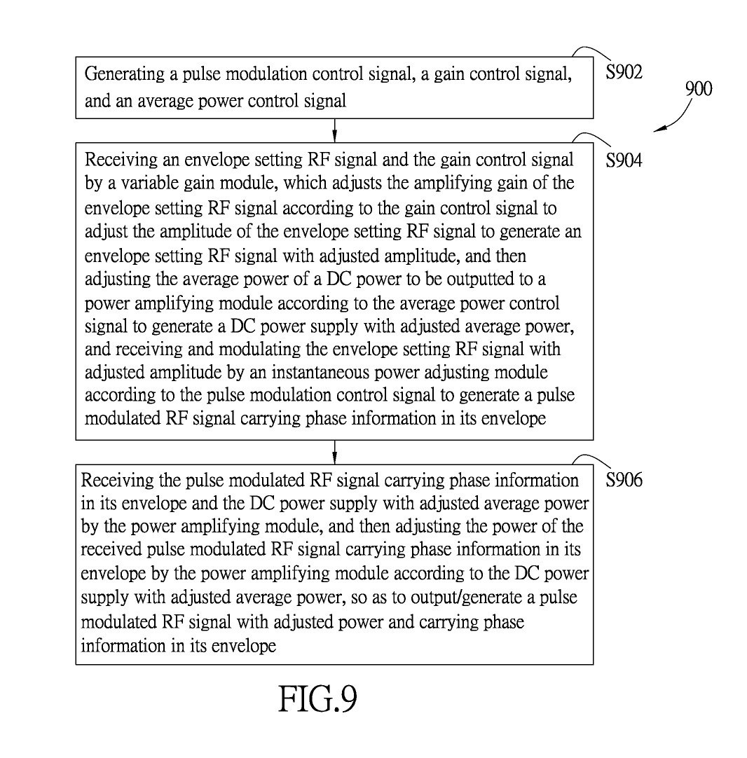

The processes of the method for generating a modulated RF signal with high dynamic range according to an embodiment of the present invention are now further described in conjunction with the system architecture shown in FIG. 1. FIG. 9 is a flowchart illustrating a method for generating a modulated RF signal with high dynamic range 900 of the present invention. In step S902, a pulse modulation control signal, a gain control signal, and an average power control signal are generated. Then, proceed to step S904.

In step S904, a constant-envelope modulated RF signal and the gain control signal are received by a variable gain module, which adjusts the amplifying gain of the constant-envelope modulated RF signal according to the gain control signal; specifically, the amplitude of the constant-envelope modulated RF signal is adjusted to generate an constant-envelope modulated RF signal with an adjusted amplitude; and then, an average power of the DC supply voltage of a DC power supply to be output to a power amplification module is adjusted according to the average power control signal to generate a DC supply voltage with the adjusted average power; thereafter, the constant-envelope modulated RF signal with the adjusted amplitude is received and modulated by an instantaneous power adjusting module according to the pulse modulation control signal to generate a pulse modulated RF signal carrying phase information. Then, proceed to step S906.

In step S906, the pulse modulated RF signal carrying phase information and the DC supply voltage with the adjusted average power are received by the power amplification module, and then the power of the received pulse modulated RF signal carrying phase information is adjusted by the power amplification module according to the DC amplifier with the adjusted average power, so as to output/generate a pulse modulated RF signal with adjusted power and carrying phase information, and the processes of the method for generating a modulated RF signal with high dynamic range of the present invention are complete.

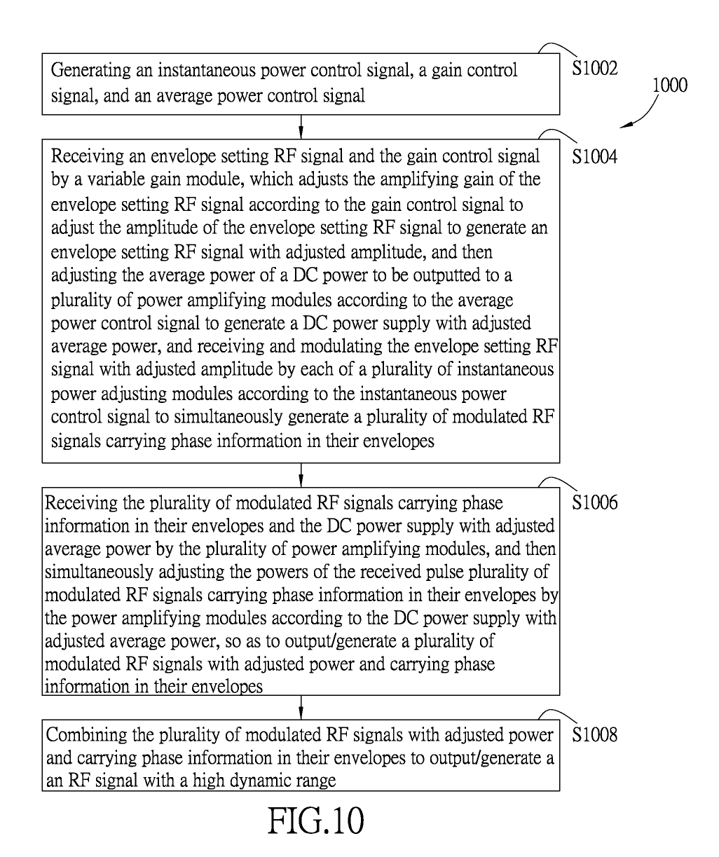

The steps of the method for generating a modulated RF signal with high dynamic range according to another embodiment of the present invention are further described in conjunction with the system architecture shown in FIG. 2. FIG. 10 is a flowchart illustrating a method for generating a modulated RF signal with high dynamic range 1000 according to the present invention. In step S1002, an instantaneous power control signal, a gain control signal, and an average power control signal are generated. Then, proceed to step S1004.

In step S1004, an constant-envelope modulated RF signal and the gain control signal are received by a variable gain module, which adjusts the amplifying gain of the constant-envelope modulated RF signal according to the gain control signal; specifically, the amplitude of the constant-envelope modulated RF signal is adjusted to generate an constant-envelope modulated RF signal with an adjusted amplitude; and then, the average power of the supply voltage from a DC power supply to be output to a plurality of power amplification modules is adjusted according to the average power control signal to generate a DC supply voltage with the adjusted average power; thereafter, the constant-envelope modulated RF signal with the adjusted amplitude is received and modulated by each of a plurality of instantaneous power adjusting modules according to the instantaneous power control signal to simultaneously generate a plurality of modulated RF signals carrying phase information. Then, proceed to step S1006.

In step S1006, the plurality of modulated RF signals carrying phase information and the DC supply voltage with the adjusted average power are received by the plurality of power amplification modules, and then the powers of the received modulated RF signals carrying phase information are simultaneously adjusted by the power amplification modules according to the DC supply voltage with the adjusted average power, so as to output/generate a plurality of modulated RF signals with adjusted power and carrying phase information. Then, proceed to step S1008.

In step S1008, the plurality of modulated RF signals with adjusted power and carrying phase information are combined to output/generate an RF signal with high dynamic range, and the steps of the method for generating a modulated RF signal with high dynamic range of the present invention are complete.

The above embodiments are provided to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for generating a modulated radio-frequency (RF) signal, comprising the steps of:
generating a pulse modulation control signal, a gain control signal, and an average power control signal;
receiving a constant-envelope modulated RF signal and the gain control signal by a variable gain module, having the variable gain module adjust magnitude of the constant-envelope modulated RF signal according to the gain control signal so as to generate a constant-envelope modulated RF signal with an adjusted amplitude, and adjust a DC supply voltage from a DC power supply to be output to a power amplification module according to the average power control signal so as to generate an RF signal power with adjusted average power, and receiving and modulating the constant-envelope modulated RF signal with the adjusted amplitude by an instantaneous power adjusting module according to the pulse modulation control signal so as to generate a pulse modulated RF signal carrying phase information; and
receiving the pulse modulated RF signal and the DC supply voltage by the power amplification module, and adjusting output power of the received pulse modulated RF signal by the power amplification module according to the DC supply voltage, so as to output/generate a pulse modulated RF signal with adjusted power and carrying phase information.

2. The method of claim 1, wherein a frequency of the pulse modulation control signal is adjusted with respect to the instantaneous power to achieve instantaneous power adjustment.

3. The method of claim 1, wherein a duty cycle of the pulse modulation control signal is adjusted with respect to the instantaneous power to achieve instantaneous power adjustment.

4. The method of claim 1, wherein the power amplification module is an RF power amplifier.

5. The method of claim 1, wherein the variable gain module is a variable gain amplifier.

6. A method for generating a modulated RF signal, comprising the steps of:
generating an instantaneous power control signal, a gain control signal, and an average power control signal;
receiving a constant-envelope modulated RF signal and the gain control signal by a variable gain module, having the variable gain module adjust magnitude of the constant-envelope modulated RF signal according to the gain control signal so as to generate a constant-envelope modulated RF signal with an adjusted amplitude, and then adjust an average power of a DC supply voltage to be output to a plurality of power amplification modules according to the average power control signal, so as to generate a DC supply voltage with the adjusted average power, and receiving and modulating the constant-envelope modulated RF signal with the adjusted amplitude by each of a plurality of instantaneous power adjusting modules according to its corresponding instantaneous power control signal to simultaneously generate a plurality of pulse modulated RF signals carrying phase information;
receiving the modulated RF signals and the DC supply voltage by the power amplification modules, and then simultaneously adjusting output power of the received modulated RF signals by the power amplification modules according to the DC supply voltage, so as to output/generate a plurality of modulated RF signals with adjusted power and carrying phase information; and
combining the modulated RF signals with adjusted power and carrying phase information in envelopes thereof to output/generate an RF signal with a high dynamic range.

7. The method of claim 6, wherein frequencies of the pulse modulation control signals are adjusted with respect to instantaneous power to achieve instantaneous power adjustment.

8. The method of claim 6, wherein duty cycles of the pulse modulation control signals are adjusted with respect to instantaneous power to achieve instantaneous power adjustment.

9. The method of claim 6, wherein a combination of the plurality of instantaneous power adjusting modules and the plurality of power amplification modules functions as a power digital-to-analog converter (DAC).

10. The method of claim 6, wherein the variable gain module is a variable gain amplifier.
